(19) United States
(12) Patent Application Publication
(10) Pub. No.: US 2025/0238172 A1
(43) Pub. Date: Jul. 24, 2025

(54) INFORMATION PROCESSING SYSTEM AND NON-TRANSITORY COMPUTER READABLE MEDIUM

(71) Applicant: Fujifilm Business Innovation Corp., Tokyo (JP)

(72) Inventor: Kenji SAWAI, Kanagawa (JP)

(73) Assignee: FUJIFILM Business Innovation Corp., Tokyo (JP)

(21) Appl. No.: 18/778,263

(22) Filed: Jul. 19, 2024

(30) Foreign Application Priority Data
Jan. 23, 2024 (JP) 2024-007731

(51) Int. Cl. G06F 3/12

(52) U.S. Cl. CPC G06F 3/1208; G06F 3/1256

(57) ABSTRACT

An information processing system includes a processor configured to: when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen, perform, in response to a moving operation to move a display area by a user, display control to: move a display area in a test chart selected by the user from among the plurality of test charts in accordance with the moving operation; and move a display area in a test chart other than the test chart selected by the user only in a direction perpendicular to the sheet feed direction in synchronization with the test chart selected by the user.

### CROSS-REFERENCE TO RELATED APPLICATIONS

This application is based on and claims priority under 35 USC 119 from Japanese Patent Application No. 2024-007731 filed Jan. 23, 2024.

### BACKGROUND

### (i) Technical Field

The present disclosure relates to an information processing system and a non-transitory computer readable medium.

### (ii) Related Art

An image forming apparatus, such as a printer, normally prints a document image on a paper medium or the like through image forming processes, such as charging, exposure, development, and transfer. The image forming apparatus may acquire an electronic document via a network or read a document with a scanner to form a document image that serves as original data for printing.

In an image forming apparatus, an image quality abnormality such as a streak may appear on a printed sheet surface due to abnormality, aging degradation, or the like of a member used for image forming, such as a charging roller or a magnet roller. In this case, the image quality abnormality is removed during maintenance work for the image forming apparatus by performing maintenance of the member causing the appearance of the image quality abnormality, among the members constituting the image forming apparatus.

In recent years, techniques have been available for determining an image forming process that is the cause of the appearance of an image quality abnormality. For example, in Japanese Unexamined Patent Application Publication No. 7-168484, by using a combination of test charts (hereinafter, referred to as “bias development images”) generated according to image forming conditions different from those during normal image forming, it is possible to check under which image forming conditions a streak appears or disappears at the time of image forming. Once the image forming process causing the occurrence of the streak is identified, maintenance staff performs work on a member that operates in the identified image forming process as a maintenance target.

There is an image forming apparatus with a function for reading a printed test chart and displaying the read image based on image forming conditions. In this image forming apparatus, if an image quality abnormality is detected in a document image, a plurality of printed bias development images are read, and the read images are displayed on a screen. By referring to the plurality of read bias development images, the maintenance staff can confirm the presence or absence of an image quality abnormality and the appearance position thereof in each bias development image, and thus determines the image forming process that is the cause of the appearance of the streak.

Examples of the related art include Japanese Unexamined Patent Application Publication No. 2007-116546.

### SUMMARY

If a plurality of test charts are to be displayed on one screen without being reduced in size, it may be impossible to display the entirety of all of the test charts on the one screen. Thus, it may be considered to cut out partial images from the test charts and display them side by side on one screen. That is, the displayed area of each test chart is not the entire test chart but is a part of the test chart. If an image quality abnormality such as a streak continuously appears on the test chart along a sheet feed direction at the time of printing of the test chart, it is possible to include the appearing image quality abnormality in the display area by cutting out an image from the test chart so as to include the entire width in a direction orthogonal to the sheet feed direction.

However, if the image quality abnormality appears intermittently in the test chart along the sheet feed direction at the time of printing of the test chart, it may not be possible to include the image quality abnormality appearing in the document image in the display area, depending on the position at which the image is cut out.

Therefore, a user may be allowed to select the area to be cut out and displayed from the test chart. For example, the user is allowed to move the position of a partial image to be displayed in the test chart, thus allowing the user to find an image quality abnormality that appears in the test chart. When the display area is moved according to the user operation, it may be considered efficient if, in synchronization with the movement of the display area in one test chart, the display areas in the other test charts are similarly moved so as to confirm the presence or absence of the image quality abnormality and the appearance position thereof while comparing the images cut out from the respective test charts.

However, if the display positions in the respective test charts are moved together in synchronization both vertically and horizontally, when the user, despite having successfully found the appearance position of the image quality abnormality in a certain test chart, performs an operation of moving the display area of another test chart, the appearance position of the image quality abnormality may deviate from the display area in the certain test chart in which the user has once found the appearance position of the image quality abnormality.

Aspects of non-limiting embodiments of the present disclosure relate to, when an image quality abnormality appears intermittently in a test chart, which is printed and then displayed by being read by a reading unit, along a sheet feed direction at the time of printing of the test chart and when a partial image is cut out from each of a plurality of test charts printed according to different image forming conditions and then displayed by being read by the reading unit, and the cut-out images are arranged and displayed on one screen, making it easier to find an appearance position of an image quality abnormality in each test chart than when the movements of display areas in both the sheet feed direction and a direction orthogonal to the sheet feed direction are displayed in synchronization among the plurality of test charts.

Aspects of certain non-limiting exemplary embodiments of the present disclosure overcome the above disadvantages and/or other disadvantages not described above. However, aspects of the non-limiting exemplary embodiments are not required to overcome the disadvantages described above, and aspects of the non-limiting exemplary embodiments of the present disclosure may not overcome any of the disadvantages described above.

According to an aspect of the present disclosure, there is provided an information processing system including: a processor configured to: when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen, perform, in response to a moving operation to move a display area by a user, display control to: move a display area in a test chart selected by the user from among the plurality of test charts in accordance with the moving operation; and move a display area in a test chart other than the test chart selected by the user only in a direction perpendicular to the sheet feed direction in synchronization with the test chart selected by the user.

### BRIEF DESCRIPTION OF THE DRAWINGS

Exemplary embodiments of the present disclosure will be described in detail based on the following figures, wherein:

FIG. 1 is a hardware configuration diagram of an image forming apparatus according to the present exemplary embodiment;

FIG. 2 is a block configuration diagram illustrating the image forming apparatus according to the present exemplary embodiment;

FIG. 3 illustrates image forming conditions when a test chart is printed according to the present exemplary embodiment;

FIG. 4A illustrates examples of test charts to be displayed, FIG. 4B illustrates an example of a screen display of the test charts, and FIG. 4C illustrates a motion of a user's hand when moving a display area;

FIG. 5A illustrates examples of the test charts to be displayed, FIG. 5B illustrates an example of the screen display of the test charts, and FIG. 5C illustrates a relative movement of a test chart with respect to the motion of the user's hand; and

FIG. 6A illustrates examples of the test charts to be displayed, and FIG. 6B illustrates an example of the screen display of the test charts in the present exemplary embodiment.

### DETAILED DESCRIPTION

Hereinafter, a preferred exemplary embodiment of the present disclosure will be described with reference to the drawings.

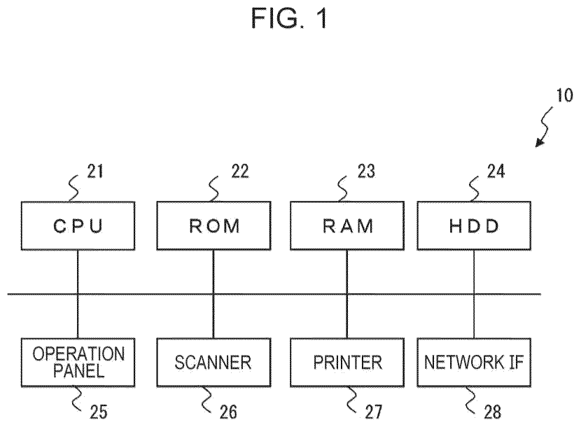

FIG. 1 is a hardware configuration diagram of an image forming apparatus 10 according to the present exemplary embodiment. The image forming apparatus 10 is a multifunction peripheral having various functions such as a print function, a copy function, and a scanner function, and is an apparatus incorporating a computer. The image forming apparatus 10 according to the present exemplary embodiment can be implemented with an existing general-purpose hardware configuration. That is, the image forming apparatus 10 incorporates a computer including at least a central processing unit (CPU) 21, a read-only memory (ROM) 22, a random access memory (RAM) 23, and a hard disk drive (HDD) 24. The image forming apparatus 10 further includes: an operation panel 25 as a user interface that functions as a display unit for displaying information and an input unit for allowing a user to input information; a scanner 26 as a reading unit for reading a document set on a document table and storing resultant electronic data in the HDD 24 or the like; a printer 27 for printing a test chart on an output sheet; and a network interface (IF) 28 as a communication unit.

As described later, in the present exemplary embodiment, images cut out from a plurality of images generated by reading what is printed according to designated image forming conditions by the reading unit are arranged and displayed on one screen. The operation panel 25 is used as the display unit to display the images in the arranged manner. Of course, the display unit is not necessarily limited to the operation panel 25, and a dedicated display device may be separately provided for the image forming apparatus 10, or a display unit included in an information processing apparatus such as a personal computer (PC) connected to the image forming apparatus 10 via a network may be used.

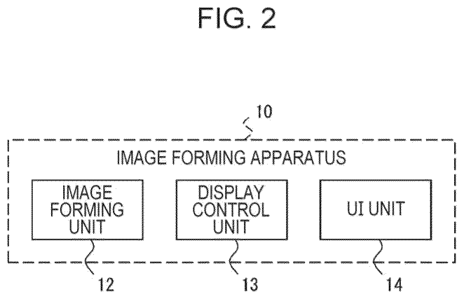

FIG. 2 is a block configuration diagram illustrating the image forming apparatus 10 according to the present exemplary embodiment. The image forming apparatus 10 according to the present exemplary embodiment includes an image forming unit 12, a display control unit 13, and a user interface (UI) unit 14. Constituent elements which are not used in the description of the present exemplary embodiment are omitted from the drawings.

The image forming unit 12 forms a test chart in accordance with a predetermined image forming process. The test chart is printed by the printer 27. The printed test chart is read and displayed on the operation panel 25. The display control unit 13 performs display control for an image in the user interface unit 14. The user interface unit 14, which is implemented by the operation panel 25, receives a user operation, and also displays an image under the display control by the display control unit 13.

Each of the constituent elements 12 to 14 in the image forming apparatus 10 is implemented by a cooperative operation of the computer forming the image forming apparatus 10 and a program run by the CPU 21 mounted in the computer.

The program used in the present exemplary embodiment may be provided not only by the communication unit but also by being stored in a computer-readable recording medium, such as a compact disc read-only memory (CD-ROM) or a Universal Serial Bus (USB) memory. The program provided from the communication unit or the recording medium is installed in the computer, and the CPU 21 of the computer sequentially executes the program to implement various kinds of processing.

While an “information processing system” according to the present exemplary embodiment is described as being composed of the single image forming apparatus 10 by way of an example, the information processing system may be composed of a plurality of apparatuses, such as the image forming apparatus 10 and an information processing apparatus, such as a PC, so that, for example, image display can be performed by the information processing apparatus as described above.

The image forming unit 12 forms a test chart in accordance with predetermined image forming processes. The predetermined image forming processes generally include processes of charging, exposure, and development, and the test chart is formed through the image forming processes. More specifically, in an image forming process called “charging”, a charging device including a charging roller is caused to exert a charging function to charge a photosensitive member. In an image forming process called “exposure,” an exposure device including a laser or the like is caused to exert an exposure function to lower the potential for a to-be-printed part of a document on the surface of the charged photosensitive member. In an image forming process called “development”, a developing device including a magnet roller is caused to exert a developing function to cause toner to adhere to the part of the photosensitive member where the potential has been lowered. In an image forming process called “transfer”, a transfer device including a transfer roller is caused to exert a transfer function to transfer the toner adhering to the photosensitive member onto a sheet.

When an image quality abnormality appears in a printed matter, it may be considered that the cause is an abnormality in the image creating function in any one of the image forming processes. For example, when a part of a member has a defect or the like, an image quality abnormality may occur in which a streak appears along a sheet feed direction of the test chart. In this case, the user can identify the image forming process that is the cause of the appearance of the image quality abnormality by comparing test charts having different image forming conditions. In the case of the present exemplary embodiment, an existing technique can be used as a predetermined diagnosis method, such as a diagnosis method described in Japanese Unexamined Patent Application Publication No. 7-168484, for example.

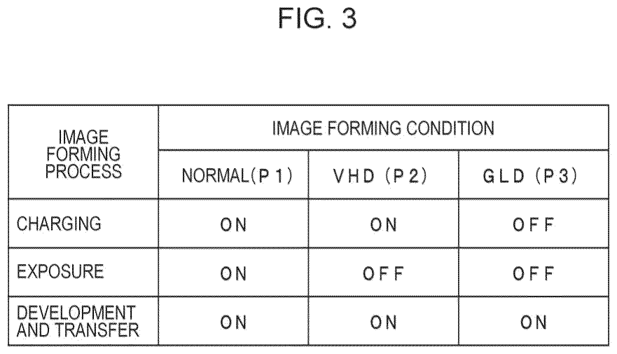

Here, while limiting the description of the diagnostic method described in Japanese Unexamined Patent Application Publication No. 7-168484 to an outline, a method for estimating the image forming process that is the cause of the appearance of an image quality abnormality using a plurality of test charts having different image forming conditions will be described with reference to a table illustrated in FIG. 3. The table may be stored in the HDD 24, or may be held inside the image forming unit 12.

In FIG. 3, the image forming processes that can be the cause of an image quality abnormality are classified into charging, exposure, and development or transfer. Since the diagnostic method described in Japanese Unexamined Patent Application Publication No. 7-168484 uses another method to distinguish between development and transfer, development and transfer are collectively illustrated in FIG. 3. The collective illustration is for the sake of convenience of description, as it is not the direct object of the present exemplary embodiment to find an image forming process that can be the cause of the image quality abnormality. The following description may refer to development as representing “development or transfer”.

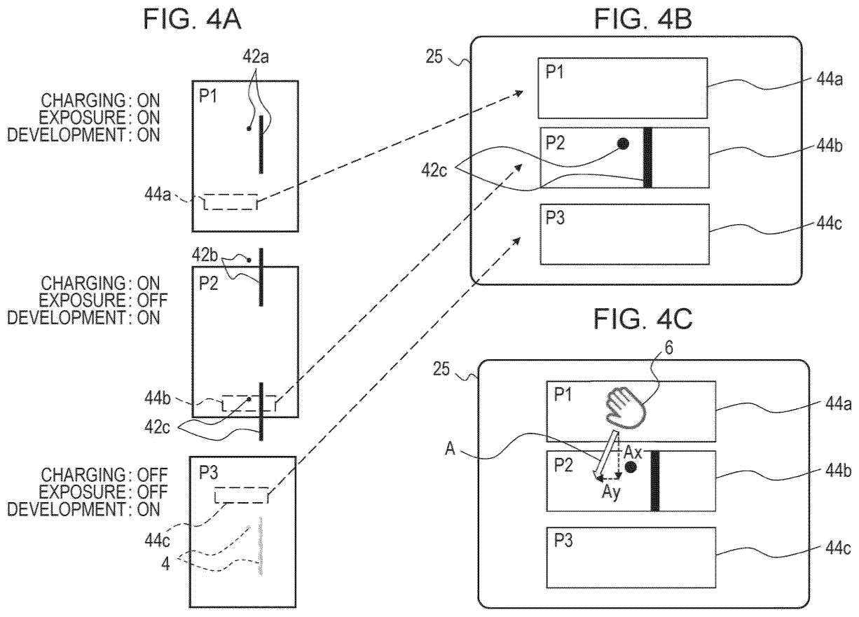

According to this diagnostic method, predetermined three types of test charts for normal, VH-bias development (VHD), and GND-level bias development (GLD) are formed. In the present exemplary embodiment, since the three types of test charts are sequentially formed page by page, the types of the test charts are indicated by page numbers in FIGS. 4A to 6B, such as the first page (P1), the second page (P2), and the third page (P3), for convenience. Furthermore, in FIG. 3, whether the inherent function of each image forming process is to be exerted is indicated by “ON” or “OFF”. For example, “ON” indicates that the function in the image forming process is exerted, whereas “OFF” indicates that the function in the image forming process is not exerted. Image forming conditions are set by the combination of “ON” and “OFF” of the respective image forming processes of charging, exposure, and development or transfer.

As described above, the “image forming conditions” are set according to whether or not the functions of the respective image forming processes are to be exerted. Under the normal image forming condition, an image is created using the functions of all the image forming processes. That is, as illustrated in FIG. 3, the image forming processes of charging, exposure, and development are caused to function. As illustrated in FIG. 3, a bias development image is generated according to an image forming condition different from the normal image forming condition, in other words, according to an image forming condition under which at least one image forming process is not caused to function.

First, a test chart corresponding to “Normal (P1)” (hereinafter, also simply referred to as a “normal chart”) is generated in accordance with a normal image forming process because each image forming process is “ON”. Therefore, an image quality abnormality of a streak appears in the “normal chart”. The normal chart is generated in accordance with the normal image forming process, and therefore corresponds to a “reference image”.

In the case of the normal chart, in the image forming process of charging (hereinafter, also referred to as a “charging process”), the surface of the photosensitive member is charged using the charging device. The voltage of the photosensitive member after charging is referred to as “VH”. In the image forming process of exposure (hereinafter, also referred to as an “exposure process”), the voltage of a to-be-printed part on the surface of the photosensitive member is lowered using the exposure device. The voltage to which VH is lowered is referred to as “VL”. In the image forming process for development (hereinafter, also referred to as a “development process”), toner is caused to adhere to the surface of the photosensitive member by using the developing device. In the normal case, a potential of Vbias (VH>Vbias>VL) is applied to the magnet roller so that the toner moves from the magnet roller to the part of the photosensitive member where the voltage is lowered to VL and adheres thereto.

Subsequently, a test chart corresponding to “VHD (P2)” (hereinafter, also simply referred to as a “VHD chart”) is generated without using the exposure function because the exposure process is “OFF”. The VHD chart is generated in accordance with an image forming condition different from the normal image forming condition, and thus corresponds to a “different image forming condition image”.

In the case of the VHD chart, “Charging” is “ON” and is the same as “Normal”. Therefore, description of the charging process is omitted. The exposure process is not performed, as mentioned above. In the development process for the VHD chart, a potential Vbias (Vbias>VH) is applied to the magnet roller so that the toner moves from the magnet roller to the part of the photosensitive member where the voltage is VH and adheres thereto.

In the case of the VHD chart, since exposure is not performed, a full-page halftone test chart is supposed to be formed unless an image quality abnormality occurs. In the present exemplary embodiment, a margin is not formed on the test chart so that a white streak can be detected. The same applies to the other test charts.

Subsequently, a test chart corresponding to “GLD (P3)” (hereinafter, also simply referred to as a “GLD chart”) is generated without using the charging function and the exposure function because the charging process and the exposure process are “OFF”. The GLD chart is generated in accordance with an image forming condition different from the normal image forming condition, and thus corresponds to a “different image forming condition image”.

In the case of the GLD chart, the photosensitive member is not charged, and therefore, the potential of the photosensitive member is 0 V (GND). The exposure process is not performed, as mentioned above. In the development process in the case of the GLD chart, a potential Vbias (Vbias>GND) is applied to the magnet roller so that the toner moves from the magnet roller to the part of the photosensitive member where the potential is GND and adheres thereto.

In the case of the GLD chart, since exposure is not performed, a full-page halftone test chart is formed similarly to the case of the VHD chart, unless an image quality abnormality occurs.

Here, the image forming process causing an image quality abnormality can be identified based on the presence or absence of a streak in the above-described three types of test charts.

First, it is assumed that a streak appears in the normal chart. Here, referring to the VHD chart, if a streak that is supposed to appear in the VHD chart does not appear, it can be presumed that this is due to the absence of exposure. Therefore, the image forming process causing the image quality abnormality can be identified as the “exposure process”. Next, referring to the GLD chart, if a streak that is supposed to appear in the VHD chart appears therein and a streak that is supposed to appear in the GLD chart does not appear therein, it can be presumed that this is due to the absence of charging. Therefore, the image forming process causing the image quality abnormality can be identified as the “charging process”. Here, if the streak appears in both the VHD chart and the GLD chart, it can be identified that the image forming process causing the image quality abnormality is the “development process” or mechanical irregularities or the like on the surface of the photosensitive member.

As described above, by using the two types of test charts (corresponding to the above-described “bias development images”) of the VHD chart and the GLD chart generated according to the image forming conditions different from the case of forming the normal chart, the user can identify the image forming process causing the streak to appear on the test chart.

As described above, if it is not possible to correctly determine whether or not a streak appears in an image which is cut out from a test chart and displayed, it is not possible to correctly estimate the image forming process causing an image quality abnormality. Therefore, a method for inspecting the presence or absence of a streak in a bias development image according to the present exemplary embodiment will be described below with reference to a screen display example illustrated in FIGS. 4B and 4C.

FIG. 4A illustrates the above-described three types of test charts, that is, the normal chart P1, the VHD chart P2, and the GLD chart P3. Further, in FIG. 4A, the image forming conditions under which the respective charts P1 to P3 are formed as in FIG. 3 are correspondingly indicated. FIG. 4A illustrates an example in which image quality abnormalities 42a to 42c appear intermittently along the sheet feed direction. The image quality abnormalities 42a to 42c are referred to collectively as an “image quality abnormality 42” when they do not need to be distinguished from each other. Although a streak and a dot are illustrated as an example of the image quality abnormality 42 in FIG. 4A, the image quality abnormality 42 is not necessarily limited thereto.

Furthermore, in FIG. 4A, a partial image is cut out from each of the charts P1 to P3 in accordance with a user operation, and a region identifying the cut-out image is a display area on the operation panel 25. Thus, the symbols 44a to 44c are referred to collectively as an “image 44” or a “display area 44” when they do not need to be distinguished from each other. FIG. 4A illustrates a state in which, after the image forming apparatus 10 cuts out the image 44 from a predetermined position in each of the charts P1 to P3 in accordance with initial settings, the user arbitrarily moves the display area 44, so that the display areas 44a to 44c in the respective charts P1 to P3 are not relatively located at the same position but are scattered.

When there is a defect or the like in a part of a member, an image defect intermittently occurs. An interval at which the image defect occurs is determined by rotation speeds of rotating members and a transport speed of the sheet during printing, a printing interval of sheets, and the like. When an image quality abnormality intermittently appears on the test chart, with respect to the sheet feed direction, the image quality abnormality 42 that has actually not disappeared may be overlooked depending on the cut-out position or range of the image 44, which may result in incorrectly determining the member causing the image quality abnormality. FIG. 4A illustrates the case where the user aligns the display area 44b for the VHD chart P2 with the position of the image quality abnormality 42c, but fails to align the display area 44a for the normal chart P1 with the position of the image quality abnormality 42a. Since the two image quality abnormalities 42b and 42c appear in the VHD chart P2, any one of them may be included in the display area 44b.

FIG. 4B illustrates an example in which, in a state where the image 44 is cut out as illustrated in FIG. 4A, the images 44a to 44c cut out from the charts P1 to P3 are arranged and displayed on one screen of the operation panel 25. The display control unit 13 may enlarge and display the images 44a to 44c that are cut out from the charts P1 to P3 and displayed if the images can be arranged and displayed on the operation panel 25. According to the example of the screen display illustrated in FIG. 4B, the appearance position of the image quality abnormality 42 from the normal chart P1 is not appropriately displayed. In the charts P2 and P3 that are the bias development images, the image quality abnormality 42 may consequently not appear; however, the image quality abnormality 42 is actually supposed to appear in the normal chart P1.

Therefore, the user performs an operation of moving the display area 44a in the normal chart P1. As illustrated in FIG. 4C, the user selects the image 44 to be moved from among the images 44 displayed on the operation panel 25. Since the operation panel 25 in the present exemplary embodiment is of a touch panel type, the user selects the image 44 the user wants to move, which in this example is the image 44a cut out from the normal chart P1, by touching the displayed image 44 with a hand 6. Of course, a method using a mouse or other pointing devices instead of the touch panel may be used. Next, the user moves the hand 6 in a direction in which the user wants to move the display area 44a in the normal chart P1 selected by the touch with the hand 6, while maintaining the state of touching the operation panel 25. Then, as the user releases the hand 6 from the operation panel 25, the movement of the display area 44a ends. FIG. 4C illustrates an example in which the user moves the hand 6 in a direction of an arrow A. Note that, because the position of the normal chart P1 displayed on the operation panel 25 is fixed, although the hand 6 is moved over to the VHD chart P2 on the display screen, this merely indicates that the user moves the hand 6 over to the VHD chart P2 in relation to an amount of movement indicated by the arrow A. The motion of the user's hand 6 indicates the movement of the normal chart P1.

The direction of arrow A can be divided into a component in the sheet feed direction and a component in a direction orthogonal to the sheet feed direction. In the image forming apparatus 10, because a shaft of the charging roller and the like that rotate when the test charts are formed are disposed in the image forming apparatus 10 along a direction orthogonal to the sheet feed direction, the direction orthogonal to the sheet feed direction will be simply referred to as the an “axial direction” in the following description. In a two-dimensional coordinate system, when the sheet feed direction is an X-axis direction and the axial direction is a Y-axis direction, the arrow A can be divided into an X component Ax and a Y component Ay, as illustrated in FIG. 4C.

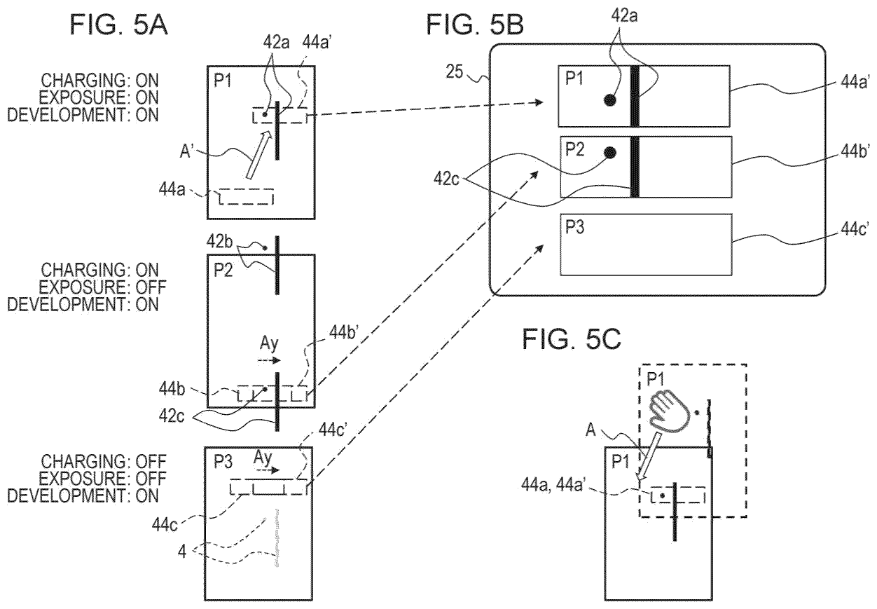

FIGS. 5A to 5C illustrate a screen display example in a case where the user moves the display area 44a in the normal chart P1. FIG. 5A illustrates the charts P1 to P3, similarly to FIG. 4A. The motion of the user's hand 6 indicates the motion for moving the normal chart P1. In FIG. 5C, the normal chart P1 is illustrated as being relatively moved with respect to the motion of the hand 6 while the display area 44a in the normal chart P1 is fixed. On the other hand, in FIG. 5A, for convenience, the position of the normal chart P1 is fixed, and the display area 44a is illustrated as being relatively moved with respect to the motion of the hand 6. Thus, in FIG. 5C, the movement direction of the display area 44a can be indicated by the arrow A, similarly to the motion of the hand 6 illustrated in FIG. 4C. Meanwhile, in FIG. 5A, the moving direction of the display area 44a is indicated by an arrow A′ which is opposite to the arrow A.

As illustrated in FIG. 5A, suppose that the display area 44a is moved to the position of a display area 44a′ on the normal chart P1 in accordance with the user operation. Accordingly, as in the screen display example illustrated in FIG. 5B, the display control unit 13 causes the operation panel 25 to display the display area 44a′ after the movement, that is, an image including the image quality abnormality 42a intermittently appearing along the sheet feed direction.

Incidentally, in the present exemplary embodiment, the charts P2 and P3 other than the normal chart P1 subject to the user operation are moved as follows in accordance with the user's moving operation on the normal chart P1.

Specifically, when the user interface unit 14 receives an operation for moving the display area 44a in the normal chart P1 selected by the user from among the charts P1 to P3 to the display area 44a′, the image forming unit 12 changes the image to be cut out from the normal chart P1 from the image 44a to the image 44a′. Thus, the display control unit 13 causes the display area 44a′ to be displayed for the normal chart P1.

In addition, in terms of the display areas 44b and 44c in the charts P2 and P3 other than the normal chart P1, the image forming unit 12, in response to the user operation, moves only the component in the axial direction of the arrow A′, that is Ay, in synchronization with the normal chart P1 selected by the user, and changes the cut-out images from the images 44b and 44c to images 44b′ and 44c′. Thus, the display control unit 13 causes the display areas 44b′ and 44c′ to be displayed for the charts P2 and P3.

In the present exemplary embodiment, the movement of the display area 44 in the charts P2 and P3 other than the normal chart P1 selected by the user is performed only in the axial direction. In other words, the display control unit 13, for the display areas 44b and 44c in the charts P2 and P3, does not synchronize the movement in the sheet feed direction of the arrow A with the movement of the display area 44a. Specifically, as illustrated in FIG. 5A, the display area 44b in the VHD chart P2 moves to the display area 44b′, and the display area 44c in the GLD chart P3 moves to the display area 44c′. Thus, as illustrated in FIG. 5B, for the image quality abnormality 42c displayed in the VHD chart P2, while the display position in the display area 44b′ moves in the axis direction, but the image quality abnormality 42c is still included in the display area 44b′. Further, the image quality abnormalities 42a and 42c in the charts P1 and P2 are displayed in a state of being aligned in the axial direction. Note that since the image quality abnormality does not appear in the GLD chart P3, no image quality abnormality is displayed in the image 44c′ cut out from the GLD chart P3 even after the display area 44 in the normal chart P1 is moved.

As described above, in the present exemplary embodiment, even when the image quality abnormality 42 intermittently appears along the sheet feed direction, it becomes easier to find the image quality abnormality 42 that may appear in each of the charts P1 to P3.

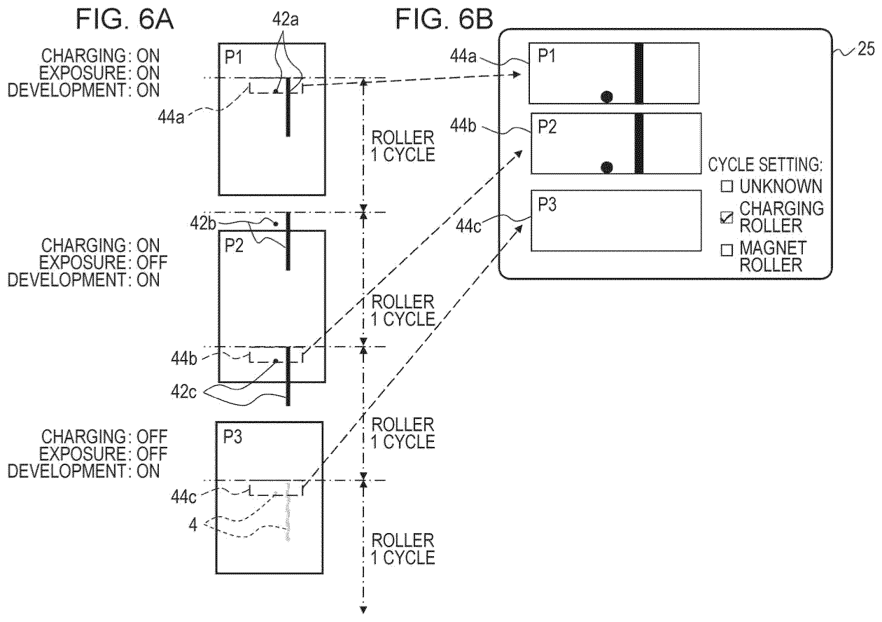

Incidentally, it can be presumed that one of the causes of the intermittent appearance of the image quality abnormality 42 along the sheet feed direction is that there is a problem only in a part in the circumferential direction of a rotating member that rotationally operates during the operation of the image forming apparatus 10. That is, while the image quality abnormality 42 appears at the position in the charts P1 and P2 corresponding to the problem, an appearance position of the image quality abnormality 42 corresponds to the rotation cycle of the rotating member, as illustrated in FIG. 6A. Note that although the image quality abnormality 42 does not appear in the GLD chart P3, an image 4 is depicted at a position where the image quality abnormality 42, if it appears, would appear in accordance with the rotation cycle of the rotating member.

Therefore, in the present exemplary embodiment, as illustrated in FIG. 6A, the image 44 is cut out from the position corresponding to the rotation cycle of the rotating member. The pitches at which a streak appears in the charts P1 to P3 correspond to the positions corresponding to the rotation cycle of the rotating member causing the image quality abnormality. For example, the pitches depend on the specifications such as the diameter and circumference of the rotating member or the operation control of the rotating member. Therefore, in the present exemplary embodiment, as illustrated in FIG. 6B, the user is allowed to select the rotating member for which the cycle is to be set. In FIG. 6B, while the charging roller or the magnet roller is illustrated as being selectable as the rotating member, other rotating members which may cause the appearance of the image quality abnormality 42 may be made selectable. When there are a plurality of faulty member candidates, by choosing from the candidates, it is possible to change the position of interest for each member and to accurately focus on the position where an image defect that is supposed to occur.

Note that the description with reference to FIGS. 4A to 5C has been given on the assumption of a case where the image quality abnormality 42 does not periodically appear. That is, this corresponds to processing in a case where the cause of the appearance of the image quality abnormality 42 is unknown and the user selects “Unknown” in FIG. 6B.

If the user knows the rotating member causing the image quality abnormality, the user may select the member from the screen illustrated in FIG. 6B. If the rotating member causing the image quality abnormality is not known, it is necessary to sequentially select the rotating members from the screen illustrated in FIG. 6B, and to find out the appearance position of the image quality abnormality 42 while moving the display area 44 in each of the charts P1 to P3 from the operation panel 25.

However, if the image quality abnormality 42 periodically appears, the image forming unit 12 fixes a position corresponding to the rotation cycle of the rotating member selected by the user, that is, the positions spaced apart by an integer multiple of the rotation cycle of the rotating member, as the position of the image 44 to be cut out, and cuts out the image 44 from each of the charts P1 to P3. In this case, unlike the case described with reference to FIGS. 4A to 5C, when the position where the image 44 is cut out from the image (for example, the “normal chart P1”) selected as being subject to movement by the user is changed, the image forming unit 12 changes the positions of the images cut out from the images (i.e., the “charts P2 and P3”) other than the selected image so as to be aligned with the selected normal chart P1 not only in the axis direction but also in the sheet feed direction. Thus, the display control unit 13 performs display control such that the display areas 44b and 44c in the charts P2 and P3 besides the normal chart P1 are moved in synchronization with the normal chart P1 with respect also to movement in the sheet feed direction. In short, the display areas 44b and 44c in the charts P2 and P3 move in synchronization with, i.e., similarly to, the movement of the display area 44a in the normal chart P1 in the sheet feed direction and the axial direction.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### APPENDIX

(((1)))

An information processing system comprising:
a processor configured to:
when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen,
perform, in response to a moving operation to move a display area by a user, display control to:
   move a display area in a test chart selected by the user from among the plurality of test charts in accordance with the moving operation; and
   move a display area in a test chart other than the test chart selected by the user only in a direction perpendicular to the sheet feed direction in synchronization with the test chart selected by the user.
      (((2)))

The information processing system according to (((1))), wherein the processor is configured to:
when, in an image forming apparatus that continuously forms the plurality of test charts, a rotating member that rotates during the printing of the test charts is selected as a member that is a possible cause of appearance of the image quality abnormality,
perform display control to:
   cut out a partial image corresponding to a position corresponding to a rotation cycle of the rotating member from each of the plurality of test charts, and arrange and display the cut-out partial images on the one screen; and
   move the display area of the test chart other than the test chart selected by the user in synchronization with the test chart selected by the user also in the sheet feed direction.
      (((3)))

A program causing a computer to execute a process comprising:
when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen,
performing, in response to a moving operation to move a display area by a user, display control to:
   move a display area in a test chart selected by the user from among the plurality of test charts in accordance with the moving operation; and
   move a display area in a test chart other than the test chart selected by the user only in a direction perpendicular to the sheet feed direction in synchronization with the test chart selected by the user.

What is claimed is:

1. An information processing system comprising:
a processor configured to:
when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen,
perform, in response to a moving operation to move a display area by a user, display control to:
move a display area in a test chart selected by the user from among the plurality of test charts in accordance with the moving operation; and
move a display area in a test chart other than the test chart selected by the user only in a direction perpendicular to the sheet feed direction in synchronization with the test chart selected by the user.

2. The information processing system according to claim 1, wherein the processor is configured to:
when, in an image forming apparatus that continuously forms the plurality of test charts, a rotating member that rotates during the printing of the test charts is selected as a member that is a possible cause of appearance of the image quality abnormality,
perform display control to:
cut out a partial image corresponding to a position corresponding to a rotation cycle of the rotating member from each of the plurality of test charts, and arrange and display the cut-out partial images on the one screen; and
move the display area of the test chart other than the test chart selected by the user in synchronization with the test chart selected by the user also in the sheet feed direction.

3. A non-transitory computer-readable medium storing a program causing a computer to execute a process comprising:
when an image quality abnormality appears continuously or intermittently in a test chart, generated according to a predetermined image forming condition, along a sheet feed direction at time of printing of the test chart and when a partial image is cut out from each of a plurality of test charts generated under different image forming conditions and the cut-out partial images are arranged and displayed on one screen,
performing, in response to a moving operation to move a display area by a user, display control to:
move a display area in a test chart selected by the user from among the plurality of test charts in accordance with the moving operation; and
move a display area in a test chart other than the test chart selected by the user only in a direction perpendicular to the sheet feed direction in synchronization with the test chart selected by the user.
